(19) United States
(12) Patent Application Publication
(10) Pub. No.: US 2013/0263142 A1
(43) Pub. Date: Oct. 3, 2013

(54) CONTROL DEVICE, CONTROL METHOD, COMPUTER READABLE RECORDING MEDIUM IN WHICH PROGRAM IS RECORDED, AND DISTRIBUTED PROCESSING SYSTEM

(71) Applicant: FUJITSU LIMITED, Kawasaki-shi (JP)

(72) Inventor: Takeshi MIYAMAE, Kawasaki-shi (JP)

(73) Assignee: FUJITSU LIMITED, Kawasaki-shi (JP)

(21) Appl. No.: 13/724,682

(22) Filed: Dec. 21, 2012

(30) Foreign Application Priority Data
Mar. 27, 2012 (JP) 2012-071000

(51) Int. Cl. G06F 9/46

(52) U.S. Cl. CPC G06F 9/46
USPC 718/102

(57) ABSTRACT

If there are a plurality of tasks to be performed for one divided data among a plurality of divided data obtained by dividing data, an allocating controller that allocates the plurality of tasks commonly to one of a plurality of processors is provided so that a processing speed is improved.

### CROSS-REFERENCE TO RELATED APPLICATION

This application is based upon and claims the benefit of priority of the prior Japanese Patent Application No. 2012-071000, filed on Mar. 27, 2012, the entire contents of which are incorporated herein by reference.

### FIELD

The embodiments discussed herein are directed to a control device, a control method, a computer readable recording medium in which a program is recorded, and a distributed processing system.

### BACKGROUND

Recently, as a processing system that processes a large quantity of data such as web data, a map-reduce type distributed processing system is known.

In the map-reduce type distributed processing system, data on the distributed processing system is divided into units called a data block and a map processing and a reduce processing are sequentially applied to the data blocks.

According to the map-reduce type distributed processing system, a series of compute processings with respect to the data blocks are distributed to be simultaneously performed in a plurality of computing nodes. A task arrangement for the computing nodes is performed by sequentially allocating map tasks, for example, registered in a FIFO (First in, First out) queue in response to the request allocated from the computing nodes.
[Patent Document 1] Japanese Laid-open Patent Publication No. 2010-218307

However, in the map-reduce type processing system of the related art, individual map tasks are separately performed. Therefore, a plurality of map tasks including the same processing target blocks are also individually performed so that the same processing target blocks are read out in the map tasks. In other words, disk accessing for reading out the processing target blocks in the map tasks occurs, which interrupts the improvement of the processing speed.

Further, by operating the map task on the file system having a cache function, the reading of the processing target block may be avoided in the performing of the second map task. However, generally, in the map-reduce type processing system, in many cases, a large volume of files which cannot be stored in the memory needs to be read. If the large volume of data is read at least once, most of cached data is purged and thus the processing target block needs to be read again.

According to an aspect, an object of the embodiment is to improve the processing speed.

Further, the embodiment is not limited the above object, but as the object and advantages which are deducted from the configurations for carrying out the invention which will be described below, the object and advantages which cannot be achieved by the related art are also one of the objects of the present invention.

### SUMMARY

The control device includes an allocating controller that commonly allocates a plurality of tasks to one of a plurality of processors when there are a plurality of tasks to be performed on one of a plurality of divided data obtained by dividing data.

Further, a control method includes commonly allocating a plurality of tasks to one of a plurality of processors when there is a plurality of tasks to be performed on one of a plurality of divided data obtained by dividing data.

In addition, in a computer readable recording medium in which a program is recorded, the program allows a computer to perform the processing: to commonly allocate a plurality of tasks to one of a plurality of processors when there are a plurality of tasks to be performed on one of a plurality of divided data obtained by dividing data.

Further, a distributed processing system, includes a plurality of processors that process a task for a plurality of divided data obtained by dividing data; and an allocating controller that commonly allocates a plurality of tasks to one of a plurality of processors when there are a plurality of tasks to be performed on one of a plurality of divided data obtained by dividing data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view schematically illustrating a functional configuration of a distributed processing system as an example of an embodiment;

FIG. 2 is a view illustrating a hardware configuration of a server of the distributed processing system as an example of a first embodiment;

FIG. 3 is a view schematically illustrating a method of managing a task by a task manager in the distributed processing system as an example of the embodiment;

FIG. 4 is a sequence diagram to explain a method of processing a map task in the distributed processing system as an example of the first embodiment;

FIGS. 5A and 5B are views illustrating a comparison of a method of allocating a task in the distributed processing system as an example of the first embodiment with a method in the related art; and

FIG. 6 is a sequence diagram to explain a method of processing a map task in a distributed processing system as an example of a second embodiment.

### DESCRIPTION OF EMBODIMENTS

Hereinafter, embodiments of a control device, a control method, a program and a distributed processing system will be described with reference to the drawings. However, the embodiments which will be described below are illustrative and are not intended to exclude the application of various modifications and technologies which are not described in the embodiments. In other words, various modifications of the present embodiments (combination of the embodiments and various modified examples) may be made without departing from the spirit of the invention. The drawings are not intended to include only components illustrated in the drawings, but may include other functions.

### (A) First Embodiment

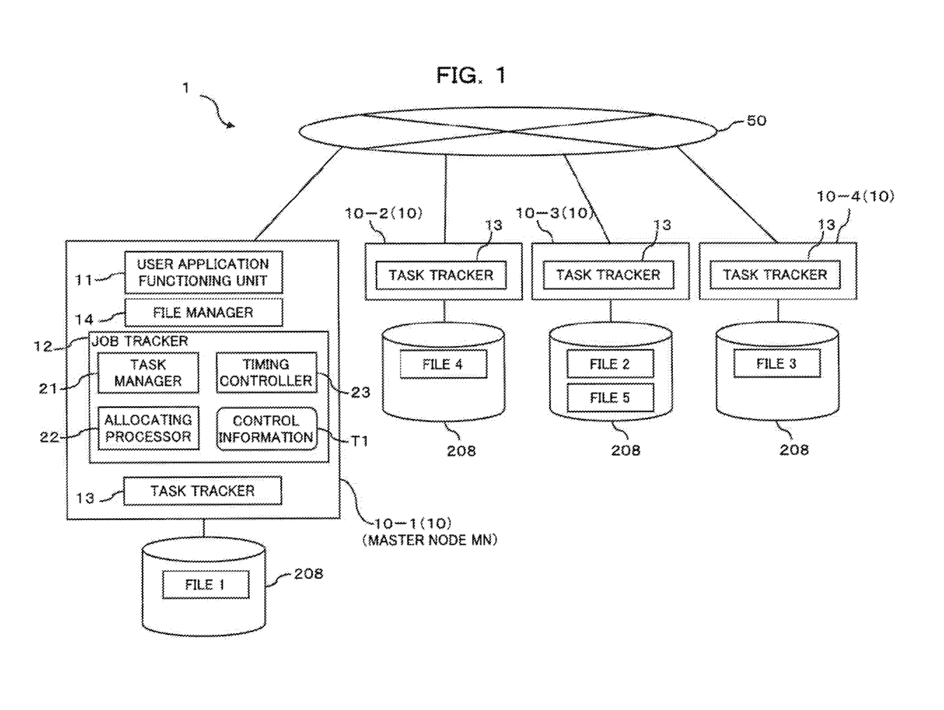

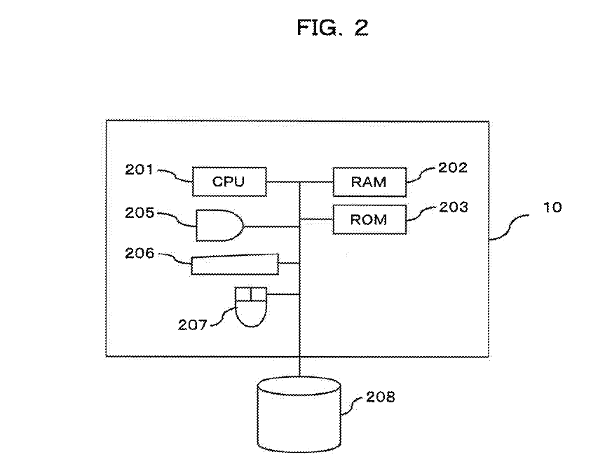

FIG. 1 is a view schematically illustrating a functional configuration of a distributed processing system 1 as an example of a first embodiment and FIG. 2 is a view illustrating a hardware configuration of a server of the distributed processing system 1.

The distributed processing system 1 includes a plurality (four in the example illustrated in FIG. 1) of servers (nodes) 10-1 to 10-4 and performs the processings so as to be distributed in the plurality of servers 10-1 to 10-4. The distributed processing system 1 is, for example, a map-reduce system that performs the distributed processing using a Hadoop (registered trademark). Hadoop is a platform of an open source that processes data so as to be distributed in a plurality of machines, which is a known technology. Therefore, the description thereof will be omitted.

The servers 10-1 to 10-4 are connected to each other so as to be able to communicate with each other through a network 50. The network 50 is, for example, a communication line such as a LAN (local area network).

Each of the servers 10-1 to 10-4 is a computer having a function of a server (information processing device). Each of the servers 10-1 to 10-4 has the same configuration. Hereinafter, as reference numerals that denote the servers, reference numerals 10-1 to 10-4 are used if it is required to specify one of the plurality of servers but a reference numeral 10 will be used to indicate an arbitrary server.

Further, in the example illustrated in FIG. 1, the server 10-1 functions as a master node and the servers 10-2 to 10-4 function as slave nodes. Hereinafter, the server 10-1 may be referred to as a master node MN and the servers 10-2 to 10-4 may be referred to as slave nodes SN.

The master node MN is a device that manages the processing in the distributed processing system 1 and allocates tasks to the plurality of slave nodes SN. The salve nodes SN perform map tasks (hereinafter, simply referred to as task) allocated by the master node MN. The plurality of slave nodes SN in which tasks are allocated to be distributed perform the allocated tasks in a parallel so as to reduce the time to process the job.

Further, in the example illustrated in FIG. 1, the master node MN also has a function as a task tracker 13 (which will be described below) and performs the allocated tasks. Accordingly, in the distributed processing system 1 illustrated in FIG. 1, the server 10-1 also serves as a slave node SN.

The server 10, for example, is a computer having a function of a server (information processing device). The server 10, as illustrated in FIG. 2, includes a CPU (central processing unit) 201, a RAM (random access memory) 202, a ROM (read only memory) 203, a display 205, a keyboard 206, a mouse 207 and a storage device 208.

The ROM 203 is a storage device that stores various data or programs. The RAM 202 is a storage device that temporally stores data or programs when the CPU 201 performs an arithmetic processing. Further, control information T1 which will be described below is stored in the RAM 202.

The display 205 is, for example, a liquid crystal display or a CRT (cathode ray tube) display and displays various information.

The keyboard 206 and the mouse 207 are input devices and a user uses the input devices to perform various inputting manipulations. For example, in the master node MN, the user uses the keyboard 206 or the mouse 207, for example, to specify a file which is a processing target or specify (input) processing contents.

The storage device 208 is a storage device that stores various data or programs, and, is for example, a HDD (hard disk drive) or a SSD (solid state drive). Further, the storage device 208, for example, may be a RAID (redundant arrays of inexpensive disks) that combines a plurality of HDDs (hard disk drives) in order to manage the plurality of HDDs as one redundant storage.

The CPU 201 is a processing device that performs various controls or arithmetic and executes a program stored in the ROM 203 to implement various functions.

In the master node MN, the CPU 201 serves as a user application functioning unit 11, a file manager 14, a job tracker 12 and a task tracker 13 which are illustrated in FIG. 1.

Further, the program that implements the functions as the user application functioning unit 11, the file manager 14, the job tracker 12 and the task tracker 13 is provided in a format, for example, recorded in a computer readable recording medium such as a flexible disk, a CD (CD-ROM, CD-R, or CD-RW), a DVD (DVD-ROM, DVD-RAM, DVD-R, DVD+R, DVD-RW, DVD+RW, or HD DVD), a blue-ray disc, a magnetic disk, an optical disk, or a magneto-optical disk. The computer reads out the program from the recording medium and transfers and stores the program to an internal storage device or an external storage device to be used. The program, for example, may be recorded in a storage device (recording medium) such as a magnetic disk, an optical disk, or a magneto-optical disk so as to be provided from the storage device to the computer through the communication channel.

When the functions as the user application functioning unit 11, the file manager 14, the job tracker 12 and the task tracker 13 are implemented, the program stored in the internal storage device (the RAM 202 or the ROM 203 in this embodiment) is executed by a microprocessor (the CPU 201 in this embodiment) of the computer. In this case, the program recorded in the recording medium may be read out by a computer to be executed.

Similarly, in the slave node SN, the CPU 201 executes the program to serve as the task tracker 13.

Further, the program that implements the function as the task tracker 13 is provided in a format recorded, for example, in a computer readable recording medium such as a flexible disk, a CD (CD-ROM, CD-R, or CD-RW), a DVD (DVD-ROM, DVD-RAM, DVD-R, DVD+R, DVD-RW, DVD+RW, or HD DVD), a blue-ray disc, a magnetic disk, an optical disk, or a magneto-optical disk. The computer reads out the program from the recording medium and transfers and stores the program to an internal storage device or an external storage device to be used. The program, for example, may be recorded in a storage device (recording medium) such as a magnetic disk, an optical disk, or a magneto-optical disk so as to be provided from the storage device to the computer through the communication channel.

When the function as the task tracker 13 is implemented, the program stored in the internal storage device (the RAM 202 or the ROM 203 in this embodiment) is executed by a microprocessor (the CPU 201 in this embodiment) of the computer. In this case, the program recorded in the recording medium may be read out by a computer to be executed.

Further, in this embodiment, the computer is a concept including hardware and an operating system, and refers to hardware which operates under the control of the operating system. If an application program solely operates the hardware while the operating system is not required, the hardware itself corresponds to the computer. The hardware includes at least a microprocessor such as a CPU and a unit of reading a computer program recorded in a recording medium. In this embodiment, the server 10 has a function as a computer.

The file manager 14 stores the file so as to be distributed in the storage device 208 of the plurality of servers 10. Hereinafter, when data is stored in the storage device 208 of the server 10, it is simply expressed as storing data in the server 10. In the example illustrated in FIG. 1, a file 1 is stored in the server 10-1, a file 4 is stored in the server 10-2, files 2 and 5 are stored in the server 10-3, and a file 3 is stored in the server 10-4.

Further, the file manager 14 divides the file (data) into segments (blocks) having a predetermined size (for example, 64 Mbyte) so as to be stored in the storage device 208 of each node. The file manager 14 manages a location of each block configuring the file (storage location). Accordingly, by inquiring of the file manager 14, the storage location of a block of a processing target may be known. An area of a segment of a file divided as described above is referred to as a split. In this distributed processing system 1, the split is defined as an area in a file. The split is generated, for example, by executing a predetermined command in the user application functioning unit 11.

In addition, the function as the file manager 14 is implemented, for example, by a Hadoop distributed file system (HDFS) and the detailed description thereof will be omitted.

The user application functioning unit 11 accepts a job request from the user, generates a Map-Reduce job (hereinafter, simply referred to as a job) and inputs the job into the job tracker 12 (job registration).

If the user application functioning unit 11 inputs the designation of a file of a processing target to be processed and processing contents (indicated contents) using the keyboard 206 or the mouse 207, the user application functioning unit 11 generates the job based on the input information.

Further, the user application functioning unit 11 inquires arrangement information of split from the command to the file manager 14 to be obtained and notifies the split which is a processing target of the job at the time of registering the job to the job tracker 12.

The job tracker (allocating controller) 12 allocates a task to an available task tracker 13 in a cluster based on the job registration performed by the user application functioning unit 11.

The job tracker 12, as illustrated in FIG. 1, includes functions as a task manager 21, an allocating processor 22 and a timing controller 23.

The task manager 21 manages a task to be allocated to the task tracker 13. The task manager 21 generates one or more tasks based on the job registration accepted from the user application functioning unit 11. As a method of generating a task based on the job, various known methods may be used and the detailed description thoseof will be omitted.

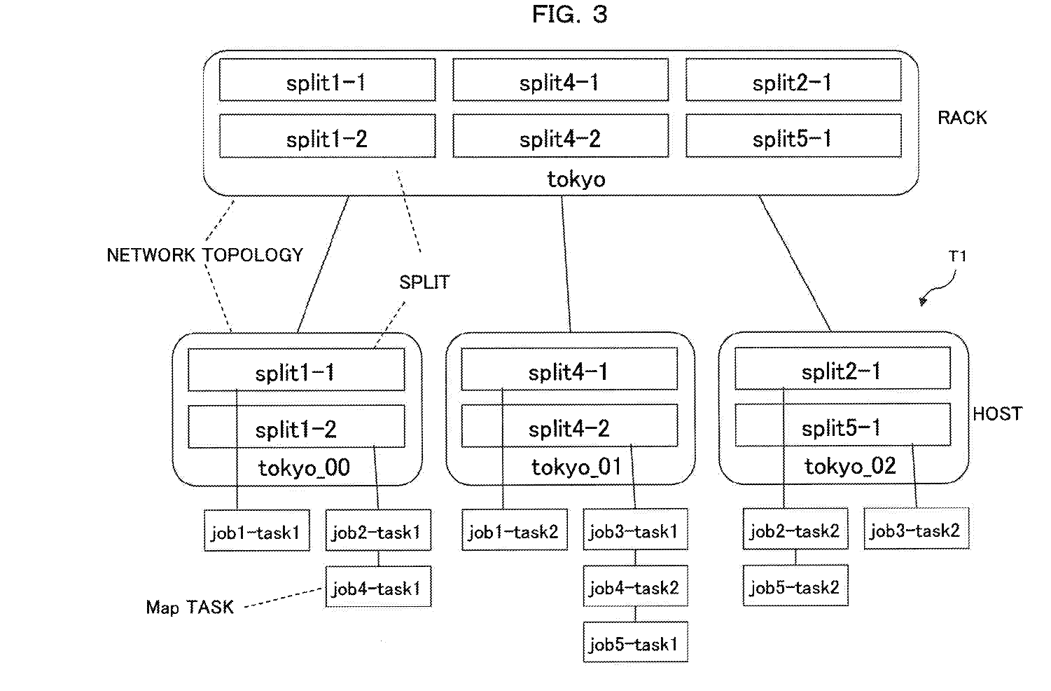

Further, the task manager 21 uses control information T1 as illustrated in FIG. 3 to manage the generated task so as to be associated with the split of the processing target of the task.

FIG. 3 is a view schematically illustrating a method of managing a task by the task manager 21 in the distributed processing system 1 as an example of the embodiment. In FIG. 3, the split is represented by split.

The task manager 21, for example, disposes the splits on the node of a network topology constructed to have a tree structure based on the setting of a system manager and registers the task therein. In this case, all tasks that correspond to the same nodes and the same splits are queued.

In the example illustrated in FIG. 3, three hosts (slave nodes SN) represented by tokyo_{—}00, tokyo_{—}01, and tokyo_{—}02 are provided. Splits 1-1 and 1-2 are mapped into the host tokyo_{—}00, splits 4-1 and 4-2 are mapped into the host tokyo_{—}01, and splits 2-1 and 5-1 are mapped into the host tokyo_{—}02. In other words, a file concerning the split 1 is stored in the storage of the host tokyo_{—}00. Similarly, a file concerning the split 4 is stored in the storage of the host tokyo_{—}01 and a file concerning the splits 2 and 5 is stored in the host tokyo_{—}02.

The hosts tokyo_{—}00, tokyo_{—}01 and tokyo_{—}02 are stored in a common rack of a data center.

The control information T1 is configured by associating the splits with the tasks. Specifically, a task that performs the processing on a split is associated with the split.

If a plurality of tasks have the same split as a processing target, the plurality of tasks are associated with the split which is the processing target. In other words, multiple tasks that have the split as a processing target are grouped with respect to one split.

In the example illustrated in FIG. 3, for example, a job 2 has two tasks (tasks 1 and 2) and the task 1 performs a processing on the split 1-2 and the task 2 performs a processing on the split 2-1.

Further, in the state illustrated in FIG. 3, for example, a task 1 of a job 2 (job2-task1) and a task 1 of a job 4 (job4-task1) are associated with the split 1-2. In other words, the job2-task1 and the job4-task1 refer to tasks having the split 1-2 as a processing target.

For example, the task manager 21 generates a link structure by setting up links between the tasks to the respective splits to be processed by the tasks to associate the splits with the tasks. Specifically, the task manager 21 sets up a link to the tasks by setting a pointer to the split which is the processing target of the corresponding task. Information of the pointer is registered in the control information T1.

By doing this, tasks that equalize the split which are a processing target, that is, multiple tasks having a common split are associated through the link.

The task manager 21 generates a task based on the accepted job whenever a job is registered by the user application functioning unit 11, associates the generated task with a split to be processed of the task and registers the generated task in the control information T1.

The timing controller 23 controls a timer (a timing unit) which is not illustrated to measure a predetermined time. The timing controller 23 instructs the timer to start to measure a predetermined time if the allocating processor 22 to be described below allocates the task to the task tracker 13.

If the measurement of a predetermined time is completed, the timer notifies the completion to the job tracker 12. The timer, for example, notifies completion of the time measurement by outputting an interrupting signal. The timing controller 23 determines that a predetermined time is being measured until an interrupting signal of the completion of the time measurement is input after the timing controller 23 instructs the timer to start to measure a time.

Further, a function as a timer may be implemented by executing a program by the CPU 201 or implemented by hardware which is not illustrated or variously modified to be performed.

The allocating processor 22 allocates a task to the task tracker 13. The allocating processor 22 allocates a task to the task tracker 13 which is a transmitting source of a request of allocating the task in response to the request of allocating the task accepted from the task tracker 13.

The job tracker 12, for example, collectively responds a next split to be processed and all tasks which are queued to the split with respect to the task tracker 13 as a response of a heartbeat protocol.

The allocating processor 22 does not allocate a task if a predetermined time does not elapse since the allocation of a previous task is performed. In the meantime, if the predetermined time elapses since the allocation of a previous task is performed, all tasks which are registered in the same splits are allocated to the same server 10 during the predetermined time. These tasks are easily obtained by referring to the control information T1.

Further, when a task is allocated to the task tracker 13, the allocating processor 22 collectively allocates all tasks which are associated with the same split (grouped) in the control information T1 to the task tracker 13.

In other words, if there are a plurality of tasks to be performed for one split, the job tracker 12 commonly allocates the plurality of tasks to one of a plurality of task trackers 13.

For example, in the example illustrated in FIG. 3, the allocating processor 22 collectively allocates job2-task1 and job4-task1 having the split 1-2 as a processing target to the task tracker 13 of tokyo_{—}00.

However, the allocating processor 22 restricts the allocation of a task to the task tracker 13 while a predetermined time is measured by the above-mentioned timer. In other words, the allocating processor 22 does not allocate the task to the task tracker 13 while the timer measures the above-mentioned predetermined time.

In the distributed processing system 1 according to the first embodiment, even when the allocating processor 22 restricts the allocation of the task to the task tracker 13 while the predetermined time is measured by the timer, the job is registered by the user application functioning unit 11. In other words, the associating of the task with the split is frequently added in the control information T1 by the task manager 21.

The allocating processor 22 preferentially allocates a task for a split which is stored in the server 10 of the task tracker 13, to the task tracker 13 which is a transmitting source of a request of allocating the task.

Further, when the plurality of tasks which are grouped in the split are allocated to the task tracker 13, the allocating processor 22 notifies information of a processing order between the plurality of tasks (for example, queue registered order) to the task tracker 13.

The task tracker 13 processes a task allocated from the job tracker 12 (allocating processor 22).

The task tracker 13 requests a task using a heartbeat protocol for the job tracker 12 at a timing when a task which is being processed is completed, or at a timing immediately after waiting for a predetermined time.

If the plurality of tasks which are grouped with respect to the same split are collectively allocated by the allocating processor 22, the task tracker 13, first, reads the split from the storage area and then sequentially processes the plurality of tasks for the read split in accordance with the processing order notified from the allocating processor 22.

Further, if the plurality of tasks are allocated to the responded split, the task tracker 13 reads out the corresponding data only once and completes all tasks before releasing the data.

By doing this, in the task tracker 13 in which the plurality of tasks grouped with respect to the same split are collectively allocated, the split is read out once to process the plurality of tasks.

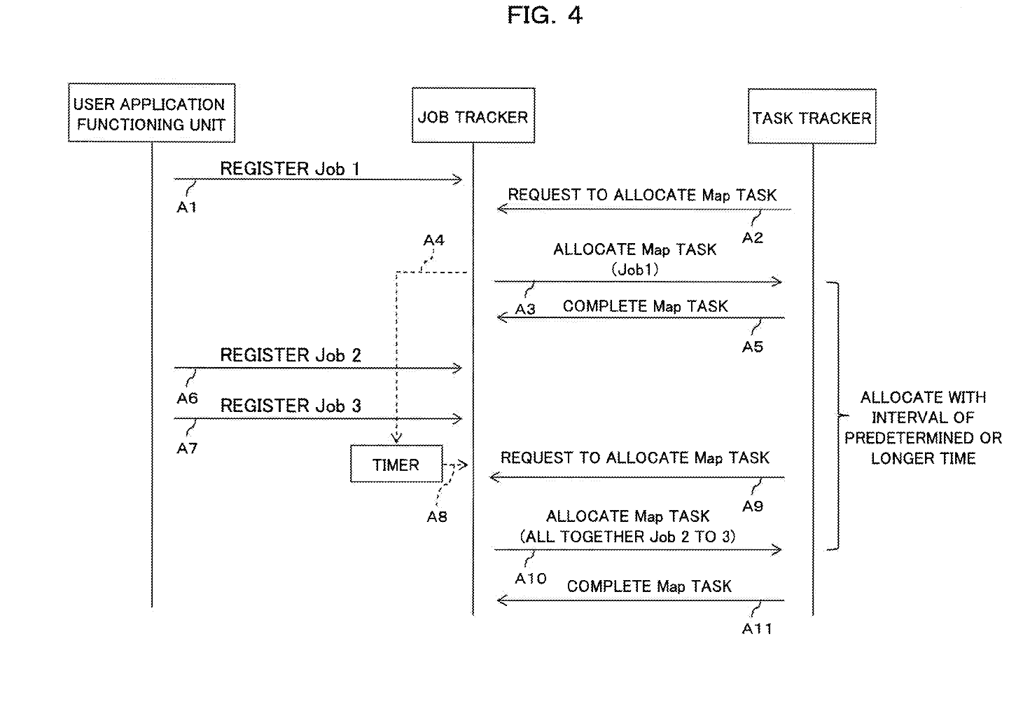

A method of processing a map task in the distributed processing system 1 as an example of the first embodiment configured as described above will be described with reference to a sequence diagram illustrated in FIG. 4. FIG. 4 is a view illustrated by focusing on one split.

For example, if the user inputs designation of a file to be processed and indicated contents using the keyboard 206 or the mouse 207, the user application functioning unit 11 generates and registers a Job 1 based on the input information (see the arrow A1).

The user application functioning unit 11 inquires arrangement information of the splits from a command to the file manager 14 and obtains the arrangement information and notifies the split which becomes a processing target of the job at the time of registering the job to the job tracker 12.

The job tracker 12 generates one or more tasks based on the job 1 registration performed by the user application functioning unit 11 and queues the generated task in the control information T1. In other words, the generated task is associated with the split which is the processing target to be registered in the control information T1.

If the task tracker 13 is in a task processable state, the task tracker 13 requests the allocation of the task to the job tracker 12 (see the arrow A2).

If a time elapsing after the allocating processor 22 allocates the task to the task tracker 13 exceeds a predetermined time which is defined in advance, the job tracker 12 allocates the task to the task tracker 13. In other words, the job tracker 12 refers to the control information T1 with respect to a request of allocating an initial task from the task tracker 13 and allocates an initial unprocessed task (a task concerning the job 1) (see the arrow A3). Further, in the job tracker 12, the timing controller 23 instructs the timer to start to measure a predetermined time (see the arrow A4). While the timer measures the time, the allocating processor 22 restricts allocation of a new task to the task tracker 13. In other words, while the timer measures a predetermined time, the job tracker 12 waits the allocation of the task.

Further, the restriction of the allocation of a new task to the task tracker 13 by the allocating processor 22 may be embodied, for example, by deterring from receiving the allocating request from the task tracker 13 or by deterring from outputting for notification of the task to the task tracker 13 or variously modified to be performed.

In the meantime, the task tracker 13 to which the task is allocated processes the allocated task and notifies the task completion to the job tracker 12 after completing the processing (see the arrow A5).

Further, while the job tracker 12 waits the allocation of the task, if the jobs Job1 and Job2 are registered (see the arrows A6 and A7), the job tracker 12 generates a task based on the registered jobs 2 and 3 and queues the task in the control information T1. In other words, the generated task is registered in the control information T1 so as to be associated with the split which is the processing target.

As described above, while the job tracker 12 waits the allocation of the task, if the job is registered, the task generated thereby is registered so as to be associated with the split which is the processing target. In this case, the tasks having the same split as the processing target are grouped to be registered in the control information T1.

In other words, while a task which is previously registered waits to be allocated, if a separate task for the same split is registered in the control information T1, the queuing is performed by registering a new task next to the previously registered task so as to be associated with the same split.

Thereafter, the timer completes to measure a predetermined time and notifies the time-up by notifying the interruption to the job tracker 12 (see the arrow A8). The job tracker 12 resumes the allocation of the task to the task tracker 13 by receiving the notification of the time-up.

Thereafter, if the task tracker 13 requests the job tracker 12 to allocate the task (See the arrow A9), since the predetermined time is not being measured, the allocating processor 22 of the job tracker 12 allocates the task to the task tracker 13 that requests to allocate the task.

In other words, the job tracker 12 allocates the task to the task tracker 13 with an interval of a predetermined time by restricting the next task allocation until a predetermined time elapses after allocating the task to the task tracker 13.

When the task is allocated to the task tracker 13, the allocating processor 22 collectively allocates all tasks which are grouped with respect to the same split in the control information T1 to the task tracker 13 (see the arrow A10). In other words, the plurality of tasks having the common split which is the processing target are synchronized to be allocated to the task tracker 13.

In this case, the allocating processor 22 preferentially allocates the tasks for the split stored in the server 10 of the task tracker 13 to the task tracker 13 which is a transmitting source of the task allocating request.

The task tracker 13 processes the plurality of allocated tasks. Since the plurality of tasks have the same split as a processing target, the plurality of tasks may be processed only by reading out the split from the storage device 208 once. In other words, the plurality of tasks is simultaneously performed by reading the data once, which allows the plurality of tasks to be processed in a shorter time.

If the task tracker 13 completes to process the plurality of allocated tasks, the task tracker 13 notifies the task completion to the job tracker 12 (see the arrow A11).

Hereinafter, the same processings are repeated.

As described above, according to the distributed processing system 1 as an example of the first embodiment, the allocating processor 22 of the job tracker 12 collectively allocates the plurality of tasks having a common split which is the processing target to the task tracker 13.

By doing this, the task tracker 13 may process the plurality of tasks only by reading out the split once from the storage device 208. In other words, a plurality of tasks may be processed in a shorter time.

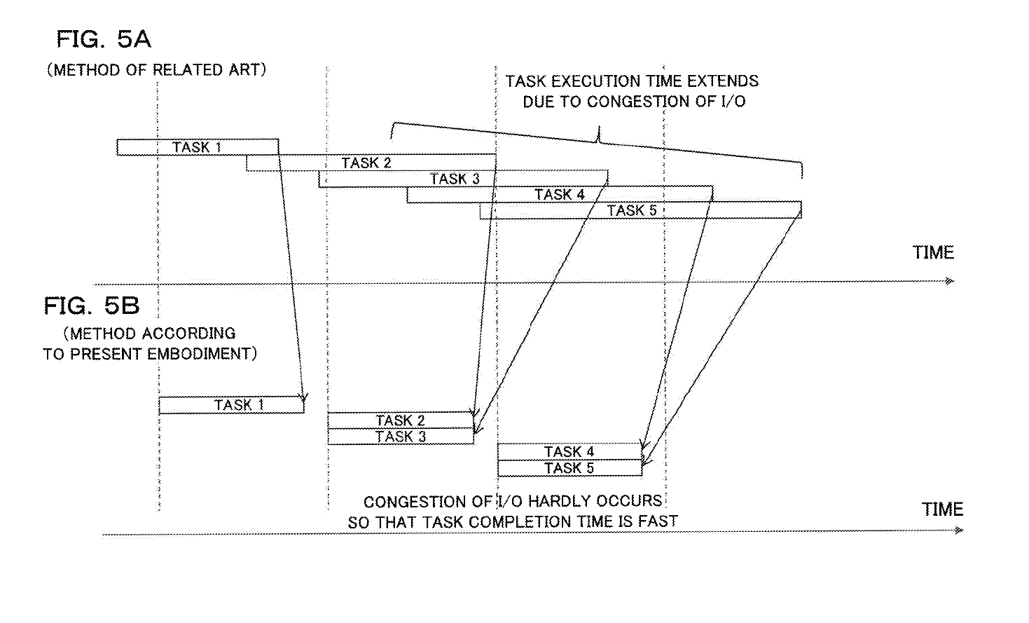

FIGS. 5A and 5B are views illustrating a comparison of a method of allocating a task in the distributed processing system 1 as an example of the first embodiment with a method of the related art in which FIG. 5A illustrates the method of the related art and FIG. 5B illustrates the method of the present embodiment.

In the method of the related art, the task tracker 13 in the slave node SN reads out the split to process the tasks whenever the tasks are processed (see FIG. 5A). Accordingly, the number of times of disk I/O (input/output) is increased and congestion of the disk I/O is generated, which increases a time required to perform the task.

In contrast, in the distributed processing system 1 according to the present embodiment, the task tracker 13 of the slave node SN may simultaneously process the plurality of tasks by reading out the split data once. By doing this, an average latency of the data reading process is improved. Further, the number of times of reading the split is reduced to reduce the number of times of disk I/O in the storage device 208. Accordingly, the congestion of the disk I/O hardly occurs in the storage device 208 and the completion time of the plurality of tasks may be shortened (see FIG. 5B).

Further, in this distributed processing system 1, the job tracker 12 manages the plurality of tasks having the common split which is the processing target which wait to be processed in the control information T1 so as to be associated with the split. By doing this, the allocating processor 22 may quickly allocate the plurality of tasks having the common split to the task tracker 13.

The job tracker 12 deters the allocation of a next task until a predetermined time elapses after allocating the task to the task tracker 13 so that the tasks are allocated to the task tracker 13 with an interval of a predetermined time. The job tracker 12 registers a task which is generated by job registration received during a predetermined period of time when the task allocation is deterred in the control information T1 so as to be associated with the split which is the processing target. As described above, the job tracker 12 deters the allocation of the task during a predetermined time to group the tasks which are generated during the time so as to be associated with the split. By doing this, it is possible to efficiently prepare the plurality of tasks having the common split.

### (B) Second Embodiment

Usually, it is required to quickly complete the Map-reduce task as soon as possible, but some cases do not. For example, there is a case that the Map-reduce task may be completed by at Time, Month, Day.

With respect to a task which does not need to hurry to complete the processing, the performance is delayed and the task is performed simultaneously with another task having the same split which is the processing target, which may reduce the number of times of reading out the split and be effective in increasing the processing speed.

Thus, in the distributed processing system 1 according to the second embodiment, a property of priority information for the task is provided and the allocating processor 22 allocates the tasks based on the priority information.

The distributed processing system 1 according to the second embodiment is different from the distributed processing system 1 according to the first embodiment in that the allocating processor 22 uses the priority information to allocate the tasks. However, the other parts are the same as the distributed processing system 1 according to the first embodiment.

As the priority information, for example, a target completion time of the task is used. The allocating processor 22 preferentially allocates a task whose target completion time is close to the task tracker 13 to be performed.

The target completion time of the task, for example, is input by a user using the keyboard 206 or the mouse 207 at the time of registering the job and the user application functioning unit 11 adds the input target completion time to the job. For example, the task manager 21 reads out the target completion time which is added to the job and sets the target completion time to the task as a property.

The distributed processing system 1 according to the second embodiment is different from the distributed processing system 1 according to the first embodiment in that the priority information (for example, target completion time) is set to the task in the control information T1 and the allocating processor 22 deters the allocation of the task if the time to the target completion time is shorter than a threshold.

Also in the distributed processing system 1 according to the second embodiment, the allocating processor 22 allocates the task to the task tracker 13. The allocating processor 22 allocates the task to the task tracker 13 which is a transmitting source of a request of allocating the task in response to the request of allocating the task accepted from the task tracker 13.

The allocating processor 22 calculates a time to the target completion time of a registered task based on the present time and compares the time to the target completion time with a threshold which is set in advance.

If the time to the target completion time is longer than the threshold, the allocating processor 22 judges that the target completion time is distant and deters the allocation of the task to the task tracker 13. Accordingly, the task is held in a registered state in the control information T1 while being associated with the split which is the processing target.

Further, if the allocating processor 22 detects a task whose time to the target completion time is shorter than the threshold (the target completion time is close) or a task whose target completion time goes by in the control information T1, the allocating processor 22 immediately allocates the task to the task tracker 13. By doing this, the delay of the processing of the task may be restricted to a minimum.

When the allocating processor 22 allocates the task whose time to the target completion time is shorter than the threshold or the task whose target completion time goes by to the task tracker 13, the allocating processor 22 also allocates the task and other tasks having the same split which is the processing target to the task tracker 13. In this case, the allocating processor 22 also notifies information of a processing order (for example, an order which is queue-registered) between the plurality of grouped tasks.

In other words, the allocating processor 22 allocates tasks having a longer remaining time to the target completion time collectively with a task having a shorter remaining time to the target completion time to the task tracker 13.

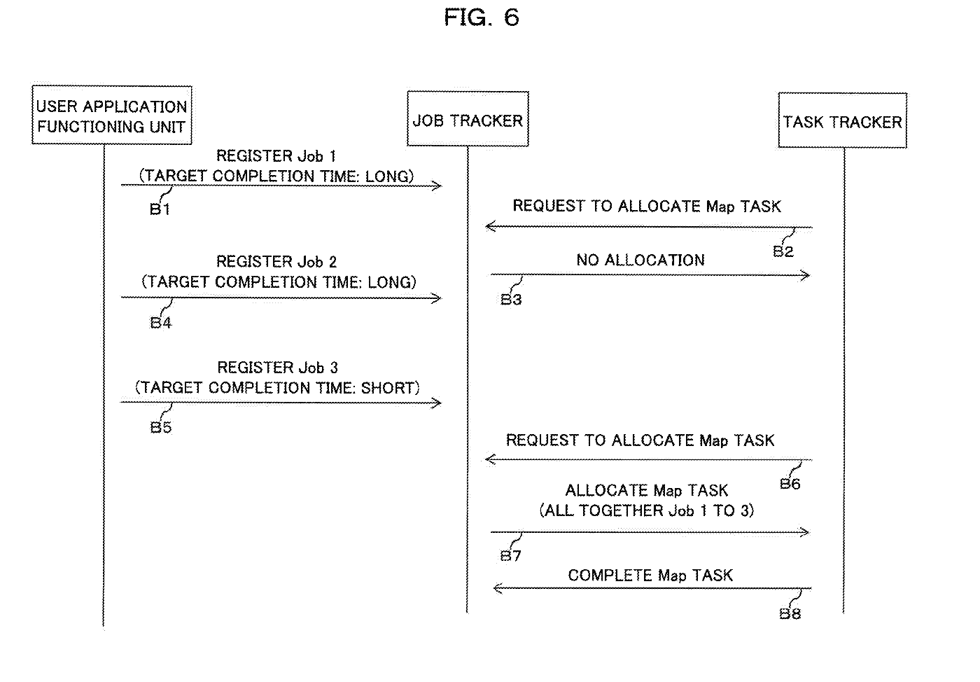

A method of processing a map task in the distributed processing system 1 as an example of the second embodiment configured as described above will be described with reference to the sequence diagram illustrated in FIG. 6. FIG. 6 is a view illustrated by focusing on one split.

For example, if the user inputs designation of a file to be processed or processing contents (indicated contents) and a target completion time using a keyboard 206 or a mouse 207, the user application functioning unit 11 generates and registers a Job 1 based on the input information (see the arrow B1). A target completion time is added to the generated job.

The user application functioning unit 11 inquires arrangement information of the splits from a command to the file manager 14 and obtains the arrangement information and notifies the split which becomes a processing target of the job at the time of registering the job to the job tracker 12.

The job tracker 12 generates one or more tasks based on the job 1 registration performed by the user application functioning unit 11 and queues the generated task in the control information T1. In other words, the generated task is associated with the split which is the processing target to be registered in the control information T1.

If the task tracker 13 is in a task processable state, the task tracker 13 requests the allocation of the task to the job tracker 12 (see the arrow B2).

Here, since the target completion time of a task concerning Job 1 is distant from the present time (priority is low), the allocating processor 22 deters the allocation of the task to the request source of the allocation of the task and does not allocate the task (see the arrow B3). In other words, the job tracker 12 waits to allocate the task.

While the job tracker 12 waits to allocate the task, if a job (Job2) is registered (see the arrow B4), the job tracker 12 generates a task based on the registered Job 2 and queues the task in the control information T1. In other words, the generated task is registered in the control information T1 so as to be associated with the split which is the processing target.

As described above, while the job tracker 12 waits to allocate the task, if the job is registered, the task generated thereby is registered in the control information T1 so as to be associated with the split which is the processing target. In this case, the tasks having the same split to be processed are grouped to be registered in the control information T1.

In other words, if other tasks for the same split are registered while the task which is previously registered in the control information T1 waits to be allocated, a new task is registered next to the previously registered task so as to be associated with the same split to perform the queuing.

Thereafter, if a Job 3 having a close target completion time is registered (see the arrow B5), the job tracker 12 resumes the allocation of the task to the task tracker 13.

Thereafter, if the task tracker 13 requests the job tracker 12 to allocate the task (the arrow B6), the allocating processor 22 of the job tracker 12 allocate the task to the task tracker 13 that requests to allocate the task.

In other words, the job tracker 12 restricts the task allocation until a task having a close target completion time (priority is high) is generated after allocating the task to the task tracker 13 to wait to allocate the task to the task tracker 13.

Further, when the task is allocated to the task tracker 13, the allocating processor 22 collectively allocates all tasks which are grouped with respect to the same split in the control information T1 to the task tracker 13 (see the arrow B7). In other words, the plurality of tasks having the common split to be processed is synchronized to be allocated to the task tracker 13.

In this case, the allocating processor 22 preferentially allocates the tasks for the split stored in the server 10 of the task tracker 13 to the task tracker 13 which is a transmitting source of the task allocating request.

The task tracker 13 processes the plurality of allocated tasks. Since the plurality of tasks have the same split as a processing target, the plurality of tasks may be processed by reading out the split from the storage device 208 only once. In other words, the plurality of tasks is simultaneously performed by reading the data once, which allows the plurality of tasks to be processed in a shorter time.

If the task tracker 13 completes to process the plurality of allocated tasks, the task tracker 13 notifies the task completion to the job tracker 12 (see the arrow B8).

Hereinafter, the same processings are repeated.

As described above, according to the distributed processing system 1 as an example of the second embodiment, similarly to the distributed processing system 1 as an example of the first embodiment, the allocating processor 22 of the job tracker 12 collectively allocates the plurality of tasks having a common split to be processed to the task tracker 13.

By doing this, in the slave node SN, the task tracker 13 may process the plurality of tasks by reading the split only once from the storage device 208, and the same effects as the first embodiment may be obtained.

Specifically, a task having a distant target completion time, that is, a low priority is deferred to be performed so that the possibility of performing simultaneously with the task having a close target completion time, that is, a high priority is increased.

Also in the distributed processing system 1 according to the second embodiment, the target completion time is used as an allocating priority of a task. By doing this, the priority is not a fixed value but the priority is increased as approaching the target completion time.

### (C) Others

The disclosed technology is not limited to the above-described embodiments and various modifications thereof may be made without departing from the spirit of the present embodiment.

For example, in the above-described embodiments, the distributed processing system 1 includes four servers 10, but is not limited thereto. The distributed processing system 1 may include three or less or five or larger servers 10. Further, the master node MN has a function as the task tracker 13, but is not limited thereto. The master node MN may not have a function as the task tracker 13.

Further, in the above-described second embodiment, the target completion time is set as priority information for the task, but the second embodiment is not limited thereto. For example, a value having a magnitude relation such as an integer (priority) may be used as the priority information.

In addition, if the priority set to the task is higher than a predetermined threshold, the task is immediately allocated to the task tracker 13 as usual. In contrast, if the priority is lower than the threshold, the allocation to the task tracker 13 is deterred and the allocation is waited so that the allocation is not performed. Accordingly, the task having a lower priority is reserved to be performed so that a possibility of being performed simultaneously with the task having a higher priority is increased.

Further, even though the priority of the task is determined, the priority may not be fixed. For example, the priority may be increased as approaching the target completion time.

In addition, a person skilled in the art may carry out or manufacture the embodiments by the above description.

According to the technology described above, the processing speed may be improved.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A control device, comprising:
an allocating controller that commonly allocates a plurality of tasks to one of a plurality of processors when there are a plurality of tasks to be performed on one of a plurality of divided data obtained by dividing data.

2. The control device according to claim 1, wherein the allocating controller temporally deters the allocation of the task to the processor after allocating the task to the processor, and associates a newly generated task with the divided data during the determent of the allocation of the task.

3. The control device according to claim 2, further comprising:
a timing controller that instructs a timer to measure a predetermined time,
wherein the allocating controller temporally deters the allocation of the task to the processor during the measurement of the predetermined time by the timer.

4. The control device according to claim 2, wherein the allocating controller associates priority information with the task, and allocates a task having a lower priority among the priority information to the processor collectively with a task having a higher priority.

5. The control device according to claim 4, wherein the priority information is a target completion time of the task, and the allocating controller allocates a task having a longer remaining time to the target completion time to the processor collectively with a task having a shorter remaining time to the target completion time.

6. A control method, comprising:
commonly allocating a plurality of tasks to one of a plurality of processors when there are a plurality of tasks to be performed on one of a plurality of divided data obtained by dividing data.

7. The control method according to claim 6, further comprising:
temporally deterring the allocation of the task to the processor after allocating the task to the processor, and
associating a newly generated task with the divided data during the determent of the allocation of the task.

8. The control method according to claim 7, further comprising:
instructing a timer to measure a predetermined time,
wherein the allocation of the task to the processor is temporally deterred during the measurement of the predetermined time by the timer.

9. The control method according to claim 7, wherein priority information is associated with the task, and a task having a lower priority among the priority information is allocated to the processor collectively with a task having a higher priority.

10. The control method according to claim 9, wherein the priority information is a target completion time of the task, and
a task having a longer remaining time to the target completion time is allocated to the processor collectively with a task having a shorter remaining time to the target completion time.

11. A computer readable recording medium in which a program is recorded, the program allowing a computer to perform the processing:
to commonly allocate a plurality of tasks to one of a plurality of processors when there are a plurality of tasks to be performed on one of a plurality of divided data obtained by dividing data.

12. The computer readable recording medium according to claim 11, wherein the program allows the computer to perform the processings:
to temporally deter the allocation of the task to the processor after allocating the task to the processor, and
to associate a newly generated task with the divided data during the determent of the allocation of the task.

13. The computer readable recording medium according to claim 12, wherein the program allows the computer to perform the processings:
to instruct a timer to measure a predetermined time, and
to temporally deter the allocation of the task to the processor during the measurement of the predetermined time by the timer.

14. The computer readable recording medium according to claim 12, wherein the program allows the computer to perform the processings:
to associate priority information with the task, and
to allocate a task having a lower priority among the priority information to the processor collectively with a task having a higher priority.

15. The computer readable recording medium according to claim 14, wherein the priority information is a target completion time of the task, and the program allows the computer to perform the processing:
to allocate a task having a longer remaining time to the target completion time to the processor collectively with a task having a shorter remaining time to the target completion time.

16. A distributed processing system, comprising:
a plurality of processors that process a task for a plurality of divided data obtained by dividing data; and
an allocating controller that commonly allocates a plurality of tasks to one of a plurality of processors when there are a plurality of tasks to be performed on one of a plurality of divided data obtained by dividing data.

17. The distributed processing system according to claim 16, wherein the allocating controller temporally deters the allocation of the task to the processor after allocating the task to the processor, and associates a newly generated task with the divided data during the determent of the allocation of the task.

18. The distributed processing system according to claim 17, further comprising:
a timing controller that instructs a timer to measure a predetermined time,
wherein the allocating controller temporally deters the allocation of the task to the processor during the measurement of the predetermined time by the timer.

19. The distributed processing system according to claim 17, wherein the allocating controller associates priority information with the task, and allocates a task having a lower priority among the priority information to the processor collectively with a task having a higher priority.

20. The distributed processing system according to claim 19, wherein the priority information is a target completion time of the task, and the allocating controller allocates a task having a longer remaining time to the target completion time to the processor collectively with a task having a shorter remaining time to the target completion time.
